(19) United States
(12) Patent Application Publication
(10) Pub. No.: US 2011/0153134 A1
(43) Pub. Date: Jun. 23, 2011

(54) Method for Finding a Clutch Slip Point of a Hybrid Vehicle

(75) Inventors: Gaetan Rocq, La Boissiere-ecole (FR); Cedric Launay, Epone (FR)

(73) Assignee: PEUGEOT CITROEN AUTOMOBILES SA, Velizy Villacoublay (FR)

(21) Appl. No.: 13/060,650

(22) PCT Filed: Sep. 4, 2009
(86) PCT No.: PCT/FR2009/051675

§ 371 Date: Feb. 24, 2011

(30) Foreign Application Priority Data
Sep. 5, 2008 (FR) 0855951

(51) Int. Cl. B60W 20/00; B60W 10/08; B60W 10/02

(52) U.S. Cl. 701/22; 180/65.265; 903/930

(57) ABSTRACT

The present invention essentially relates to a method for finding a slip point of a hybrid vehicle (1) having an electrically towed rear axle. In said method, the electrical machine (17), when starting the vehicle, is actuated to provide the vehicle drive, the engine (7) being turned off, the clutch (10) being open, and the transmission (8) being in neutral. Once the speed of the main shaft has reached a threshold (K′1), the acceleration of said main shaft is measured and stored as a reference value, and the closing of the clutch (10) is gradually controlled. Once it has been detected that the change in acceleration (ΔWAP/Δt) of the main shaft relative to the reference value has reached a threshold (K′2), the position of the clutch (10) is stored in order to deduce therefrom the position of the slip point (PP).

The present invention relates to a method for adaptive learning of the clutch slip point of a hybrid vehicle. Clutch slip point is understood to be the position of the clutch in which the two clutch plates start to slip against each other in order to transmit torque.

The specific goal of the invention is to allow adaptive learning of the slip point when the combustion engine is turned off.

The invention is applied in the domain of hybrid vehicles provided with two types of energy, thermal and electrical energy, the combination of which provides traction to the vehicles while optimizing the energy efficiency and therefore reducing fuel consumption and pollution. These vehicles are capable of driving independently thanks to the thermal energy of the internal combustion engine or thanks to the electrical energy of an electrical traction machine.

More particularly, the invention is advantageously applied in the domain of hybrid vehicles, which combine the use of an electrical drivetrain providing electrical traction to one of the axles of the vehicle and a thermal drivetrain providing thermal traction to the other axle of the vehicle.

The thermal drivetrain comprises an internal combustion engine and a transmission connected to the wheels. A clutch is connected on one side to the combustion engine and on the other side to the transmission input shaft, while the output shaft of the transmission is connected to the wheels through the intermediary of an axle. An independent starter system for the combustion engine consisting of a controlled starter can be connected to the combustion engine to ensure starting.

The electrical drivetrain consists of an electrical machine coupled to the wheels through the intermediary of a gear box, this electrical machine is connected with an energy storage device, such as a battery power supply, which supplies energy when the machine operates in motor mode or stores energy when the machine operates in generator mode.

Over the life of the vehicle, the position of the clutch relative to the slip point varies specifically as a function of the wear of the clutch plates and the conditions of use of the clutch. It is therefore useful to establish a learning strategy for the clutch slip point, in order to recalibrate the transfer function based on the clutch position and the transmitted torque, and to optimize the torque transmitted by the clutch. The objective of this function is therefore to improve the reliability and consistency of the clutch torque transmission performance during start and gear shifting.

A known adaptive learning method for the slip point tailored to hybrid vehicles comprises an electrical machine connected in series with a combustion engine through the intermediary of a clutch. This method finds the slip point by detecting a change in the speed of the electrical machine. This method, illustrated in FIG. 1, is employed at each start of the vehicle, when the combustion engine is started, and before the driver has engaged the transmission.

More precisely, the upper part of FIG. 1 shows a diagram indicating the change in time of the speed WMTH of the combustion engine and the speed WMEL of the electrical machine, and in the lower part, the change in time of the clutch position Pemb. The position PO corresponds with the disengaged position of the clutch, while the position PF corresponds with the engaged position of the clutch.

In a first phase A, when the clutch is disengaged to the maximum, the combustion engine is started, and the engine speed WMTH is regulated to a preset value K1.

In phase B, once the speed WMTH is stabilized and the transmission is in neutral, the clutch is slowly engaged in order to transmit a low torque to the electrical machine and to bring it up to speed.

At the start of phase C, at time t1 when a delta speed ΔWMEL is detected, greater than a calibrated threshold, the position of the clutch actuator is stored in memory and the position of the “licking” point PP of the clutch is deduced.

This strategy has the advantage of being simple, but poses a problem in the case of hybrid vehicles with an electrically driven rear axle. Indeed, with this type of architecture, when the vehicle is stopped, the actual situation in which the combustion engine is running, the clutch is disengaged and the transmission is in neutral, is no longer encountered, because the start of the vehicle is done by the electrical machine which is located in the rear of the vehicle.

Hybrid architectures with an electrically driven rear axle, therefore require an adaptive learning strategy for the slip point that uses the elements of the vehicle in an alternative manner.

The invention satisfies this requirement by proposing a method in which the clutch slip point is deduced starting from the measurement of the change in acceleration of the transmission input shaft during a progressive engagement of the clutch, when the vehicle runs in electric mode.

More precisely, in the method according to the invention, the vehicle is started and runs in electric mode, the clutch is disengaged and the transmission is in neutral, in other words in the dead point. The combustion engine is turned off and the transmission is in neutral for the whole duration of the process.

The rotation of the front wheels drives the input shaft of the transmission at a speed which is not zero, and which depends on the speed of the vehicle and the internal friction of the transmission. Once the speed of the input shaft is greater than a calibrated threshold, the acceleration of the input shaft is calculated and stored in memory as a reference value.

The clutch is then engaged in a controlled manner in order to transmit the clutch torque to the transmission input shaft and to disrupt in this way its change in speed.

As soon as a change is detected in the acceleration of the transmission input shaft, by comparing the actual acceleration to the reference acceleration, which is greater than a second calibrated threshold, the position of the clutch actuator is stored in a memory to deduce from it the clutch slip point.

In this way, the invention allows the recalibration of the slip point of the coupling system during the whole life of the vehicle, specifically during each phase of pure electric driving. To be noted that in general, these electric driving phases take place in the city when the vehicle drives at a speed lower than a threshold speed.

The invention relates therefore to a learning method for the slip point of a hybrid vehicle equipped with a thermal drivetrain providing traction to one of the axles of the vehicle and an electrical drivetrain providing traction to the other axle of the vehicle,
the thermal drivetrain comprises an internal combustion engine, a transmission coupled to the wheels, and a clutch connected on one side to the combustion engine and on the other side to the transmission input shaft,
the electrical drivetrain comprises in particular an electrical machine coupled to the wheels, characterized in that,
   when the vehicle starts, the electrical machine is activated to provide traction to the vehicle, while the combustion engine is turned off, the clutch is disengaged, and the transmission is in neutral.
   the acceleration of said transmission input shaft is measured and stored in memory as a reference value, and the engagement of the clutch is progressively commanded, and
   as soon as a change is detected in the acceleration of the transmission input shaft greater than a threshold value, the change in acceleration being equal to the difference between the measured acceleration of the input shaft and the reference value, the position of the clutch is stored in memory in order to deduce from it the position of the slip point.

According to an implementation mode, the threshold for the change in acceleration is calibrated and is for instance 0.5 m·s⁻².

According to an implementation mode, the reference acceleration value is measured and calculated as soon as the speed of the transmission input shaft is detected to be greater than a threshold value.

According to an implementation mode, the speed threshold is calibrated and is for instance 500 rev/min.

According to an implementation mode, the position of the clutch is measured at the location of the concentric abutment of the clutch shifter fork.

According to an implementation mode, once the slip point is stored in memory, the clutch is disengaged again.

According to an implementation mode, the change in acceleration threshold corresponds with the position of the slip point.

According to an implementation mode, the thermal drivetrain provides traction to the front axle of the vehicle and the electrical drivetrain provides traction to the rear axle of the vehicle.

The invention relates furthermore to a hybrid vehicle employing the adaptive learning method for the slip point according to the invention.

The invention will be better understood by reading the following description and by examining the accompanying figures. These figures are provided for illustration purposes only and are in no way limiting the scope of the invention. They show:

FIG. 1 (already described): time diagrams of the change of the parameters of the control elements of the vehicle when employing a slip point learning method according to the state of technology;

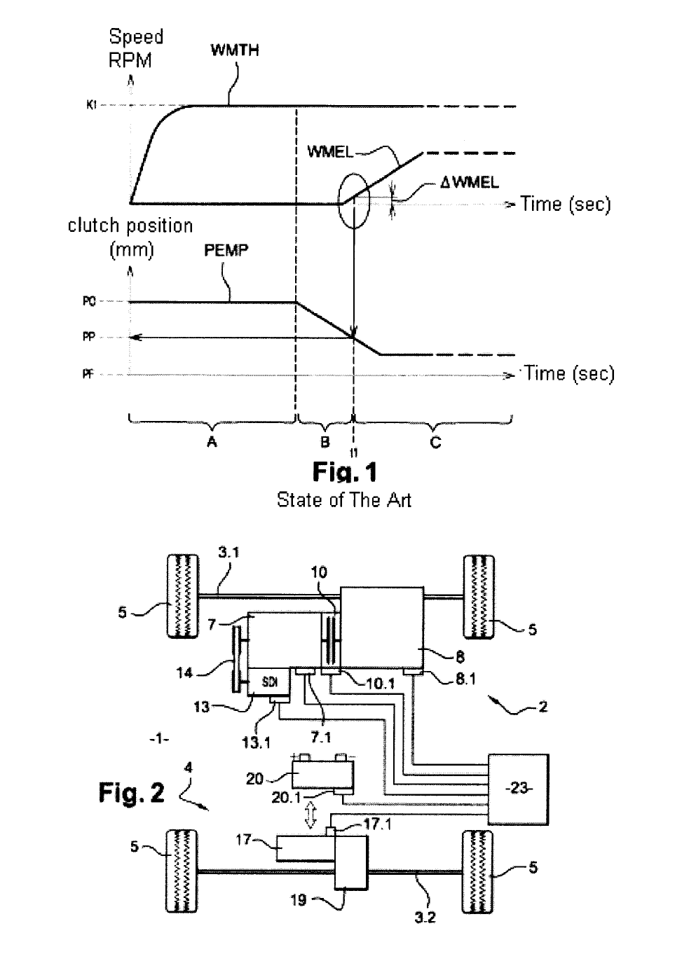

FIG. 2: a schematic representation of a hybrid vehicle according to the invention with electrically driven rear axle employing the method according to the invention;

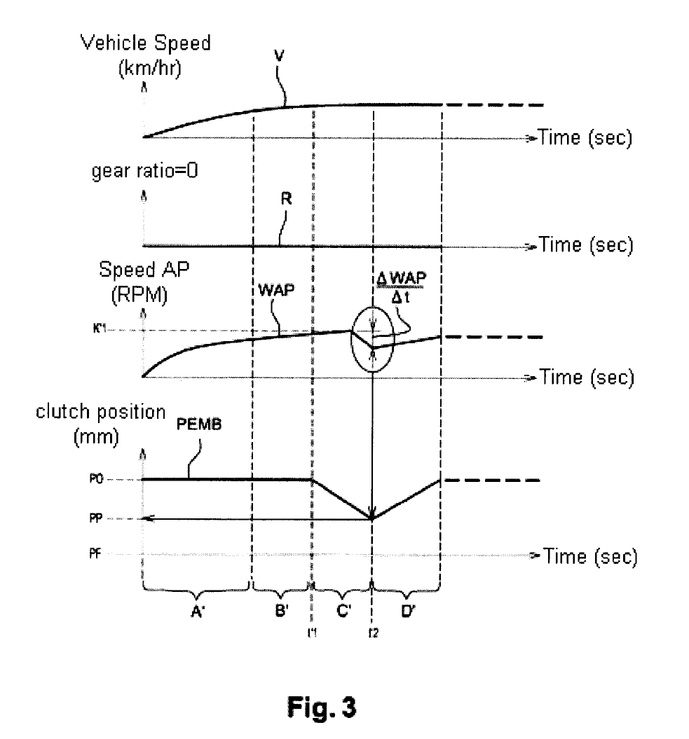

FIG. 3: time diagrams of the change of the parameters of the control elements of the vehicle when employing the slip point learning method according to the invention.

Identical elements retain the same reference from one figure to another.

FIG. 2 shows a hybrid vehicle 1 according to the invention, equipped with a thermal drivetrain 2 providing traction to the front axle 3.1 of the vehicle and an electrical drivetrain 4 providing traction to the rear axle 3.2 of the vehicle. The wheels of the vehicle are indicated by reference 5.

The thermal drivetrain 2 comprises in particular an internal combustion engine 7, using gas or diesel or any other fuel, and equipped with a flywheel and a transmission 8 with N speeds, either manually or automatic controlled, or in any other way, connected to wheels 5.

A clutch 10 is connected on one side to the combustion engine 7 and on the other side to the input shaft of transmission 8. Clutch 10 can be a dry clutch, a wet clutch or any other type of clutch. The output shaft of transmission 8 is connected to the wheels 5 through the intermediary of an axle (not shown).

A starter system 13, independent of the engine 7, is connected to the engine 7 through the intermediary of a coupling 14 in order to start the engine. This starter system 13 can consist of a controlled starter consisting of a small electric motor or any other device, while the coupling system 14 can be in the form of a belt drive.

The electrical drivetrain 4 consists in particular of an electrical machine 17 coupled to wheels 5 through the intermediary of a gear reducer 19. This electrical machine 17 is linked to an energy storage device 20, such as a battery power supply, which supplies energy when machine 17 is operating in motor mode or stores energy when machine 17 is operating in generator mode.

Each element 7, 8, 10, 13, 17, 20 is controlled by a nearby processor 7.1, 8.1, 10.1, 13.1, 17.1 and 20.1 which is in turn controlled by a single processor, called the supervisory processor 23, which makes the decisions and synchronizes the actions of the different elements 7, 8, 10, 13, 17, 20 in response to the commands of the driver.

As a function of the actual situations and the status of the vehicle, this processor 23 controls the thermal drivetrain 2 and the electrical drivetrain 4, decides the driving mode, coordinates all the transitory phases and selects the operating points of the different control elements, in order to optimize fuel consumption and depollution.

In this way, processor 23 commands elements 7, 8, 10, 13, 17, 20 so that the vehicle operates in an electrical mode when the vehicle speed is lower than a threshold speed. While the processor 23 commands elements 7, 8, 10, 13, 17, 20 so that the vehicle operates in a thermal mode when the vehicle runs at a speed higher than the threshold speed. In the recuperation phases, which occur during braking, the processor ensures in particular that machine 17 operates in generator mode to transform the kinetic energy of the vehicle to electrical energy and to store the energy in the storage device 20.

FIG. 3 shows, from high to low, a diagram indicating the change in speed V of the vehicle 1 (in kilometers per hour km/h) as a function of time, the change of the ratio R of transmission 8 as a function of time, the change of the speed WAP of the input shaft of the transmission 8 (in revolutions per minute rev/min) as a function of time, and the change of the position of clutch 10 (in millimeter) as a function of time, the position PO corresponds with the disengaged position of clutch 10, the position PF corresponds with the engaged position of clutch 10.

In the course of a first phase A′: vehicle 1 is started and runs in pure electrical mode, in other words, electrical machine 17 is activated and combustion engine 17 is turned off. Clutch 10 is disengaged and transmission 8 is in neutral. To be noted that engine 7 remains off and transmission 8 remains in neutral during the whole slip point learning procedure, from step A′ to step D′.

The rotation of front wheels 5 drives the input shaft of transmission 8 at a speed which is not zero and which depends on the vehicle speed V and the internal friction of transmission 8. Indeed, even if the input shaft and the output shaft of transmission 8 are not connected by dog tooth couplers, when the transmission 8 is in neutral, the rotation of the front axle and therefore of the output shaft of transmission 8 drives the input shaft of transmission 8 due to the internal friction between the different gears of transmission 8.

Phase B′ constitutes the continuity of phase A′. However, at the end of phase B′, at time t′ 1, as soon as processor 23 detects that the speed WAP of the input shaft of transmission 8 is greater than a first calibrated threshold K′1, processor 23 calculates and stores the acceleration of this input shaft as reference acceleration.

This first threshold K′1 depends in particular on the type of transmission 8 and the type of clutch 10 used. In one example, for a vehicle comprising a dry disc clutch 10 and a manual transmission 8 with automated shifting, the first threshold K′1 is 500 rev/min. This first threshold K′1 is for instance determined on a test bench or by simulation.

As soon as the processor has detected that this threshold K′1 has been exceeded and has stored in memory the acceleration of the input shaft, phase C′ starts in which processor 23 commands the progressive engagement of clutch 10, so that the torque is transmitted via clutch 10 to the input shaft of transmission 8 and in this way, the change in speed WAP of the input shaft is disrupted.

At the end of phase C′, at time t′2, as soon as processor 23 detects a change in the acceleration ΔWAP/Δt of the input shaft, corresponding with the difference between the measured acceleration of the input shaft and the reference acceleration, greater than a second calibrated threshold K′2, the position of the clutch actuator is stored in memory to deduce from it the slip point PP of clutch 10.

Here, the second detected threshold K′2 corresponds with the position of the slip point PP, in other words, when processor 23 detects that the change in acceleration reaches this second threshold K′2, processor 23 knows that clutch 10 is in the slip point position PP. In a variant, the second threshold K′2 corresponds with a position away from slip point PP starting from which processor 23 knows a priori how to find the slip point position PP, for instance starting from a curve as a function of the change in acceleration of the input shaft relative to the position of clutch 10.

The second threshold K′2 corresponding to the slip point PP depends of course of the type of transmission 8 and the type of clutch used. For instance, for a hybrid vehicle 1 with a dry disc clutch 10 and a manual transmission 8 with automated shifting, the second threshold K′2 is 0.5 m·s⁻². This second threshold K′2 is for instance determined on a test bench or by simulation.

The clutch position can be memorized for instance at the location of the concentric abutment of the shifter fork of clutch 10 which is displaced by an actuator.

Once the slip point PP position is stored in memory, phase D′ starts, in which clutch 10 is disengaged again to end the procedure.

In a variant, the thermal drivetrain 2 provides traction to the rear axle of the vehicle; while the electrical drivetrain 4 provides traction to the front axle of the vehicle.

1. A method for learning a slip point for a hybrid vehicle having front and rear axles; the vehicle being equipped with a thermal drivetrain providing traction to one of the axles of the vehicle and an electrical drivetrain providing traction to the other axle of the vehicle; wherein
the thermal drivetrain comprises an internal combustion engine, a transmission having an input shaft and being operatively connected to the wheels, and a clutch connected on one side to said thermal engine and on the other side to the input shaft of transmission,
the electrical drivetrain comprises an electrical machine operatively connected to wheels;
wherein, the method comprises the steps of:
when the vehicle starts, activating the electrical machine to provide power to the vehicle, while the internal combustion engine is turned off, the clutch is disengaged, and the transmission is in neutral,
progressively commanding engagement of the clutch, measuring the acceleration of said input shaft and storing the acceleration in memory as reference value, and
storing the position of the clutch in memory as soon as a change in acceleration is detected (ΔWAP/Δt) of the input shaft of transmission greater than a change-in-acceleration threshold (K′2), the change in acceleration being equal to the difference between the measured acceleration of the input shaft and the reference value, to deduce from the position of the clutch the position of the slip point (PP).

2. The method according to claim 1, wherein a threshold (K′2) of the change in acceleration is calibrated and is for instance 0.5 m/sec².

3. The method according to claim 1 wherein the reference acceleration value is measured and calculated as soon as the speed (WAP) of the input shaft of transmission is detected to be greater than a speed threshold (K′1).

4. The method according to claim 3, wherein the speed threshold (K′1) is calibrated and is for instance 500 rev/min.

5. The method according to claim 1 wherein the position of the clutch is measured at the location of a concentric abutment of a shifter fork of the clutch.

6. The method according to claim 1 wherein once the position of the slip point (PP) is stored in memory, the clutch is disengaged.

7. The method according to claim 1 wherein the change-in-acceleration threshold (K′2) corresponds with the position of the slip point (PP).

8. The method according to claim 1 wherein the thermal drivetrain provides power to the front axle of the vehicle while the electrical drivetrain provides power to the rear axle of the vehicle.
